(19) United States
(12) Patent Application Publication
(10) Pub. No.: US 2013/0277437 A1
(43) Pub. Date: Oct. 24, 2013

(54) SPRING CYCLE COUNTER

(71) Applicant: Jeff Longyear, Port Byron, NY (US)

(72) Inventor: Jeff Longyear, Port Byron, NY (US)

(21) Appl. No.: 13/922,804

(22) Filed: Jun. 20, 2013

Related U.S. Application Data
(63) Continuation-in-part of application No. 13/603,969, filed on Sep. 5, 2012.
Application No. 13/603,969 is a continuation-in-part of application No. 12/835,992, filed on Jul. 14, 2010, now abandoned.

(51) Int. Cl. G06M 1/00

(52) U.S. Cl. CPC G06M 1/00
USPC 235/91 R

(57) ABSTRACT

A spring cycle tracker system for a door mounted on a track having at least one spring, with the door having an open and closed position. The system has at least one sensed element and a tracker. The tracker has a sensor having at least one sensing element; and a controller having a counter display, at least one input signal from the at least one sensing element and at least one output signal. The sensed element and the tracker are mounted such that when the door is moved towards the open position and/or the closed position, the sensed element and the controller are moved relative to each other so that the sensing element senses the sensed element, sending an input signal to the controller, incrementing the counter display, tracking a number of times the spring is used.

### REFERENCE TO RELATED APPLICATIONS

This application is a continuation-in-part of copending patent application Ser. No. 13/603,969, filed Sep. 5, 2012, entitled “SPRING CYCLE COUNTER” which in turn is a continuation-in-part of patent application Ser. No. 12/835,992, filed Jul. 14, 2010, entitled “DOOR CYCLE TRACKER” which is now abandoned. The aforementioned applications are hereby incorporated herein by reference.

### BACKGROUND OF THE INVENTION

1. Field of the Invention

The invention pertains to the field of spring cycle trackers. More particularly, the invention pertains to a spring cycle tracker for an overhead door.

2. Description of Related Art

Many residential homes and businesses use overhead doors. Springs are used to aid in opening and closing overhead doors. The springs are very tightly tensioned. Most springs used with overhead doors have a life of about 10,000 cycles or about 10 years of normal use, with each spring cycle being equal to one opening and one closing of an overhead door or a door cycle. A breaking spring that is not properly contained may lash out and strike people and/or damage property.

One approach to solving this problem is to count the number of times a door has been opened and closed, and compare that number to a spring specification that indicates the useful life of the spring based on the number of times it has been cycled from a relaxed state to a fully tensioned state. For example, Krsnak et al. (U.S. Pat. No. 6,318,024 B1) discloses a processor based counter that works in conjunction with a motorized door opener.

However, as Krsnak's device bases counts on inputs from the door opener operator control or the door opener directional control system, there is no way to implement the device in a conventional manually operated door. As counterbalance springs are used in all manner of large doors, whether motorized or manually operated, this reliance on a motor driven opener limits the applicability of Krsnak's device in actual practice. Further, Krsnak discusses discriminating between full open/close cycles where the door has moved “a reasonable distance from the fully closed position”, and door operations in which the door is only partially opened or closed and then returned to its starting position or in which intermediate door stoppages occur. Krsnak does not count the partial cycles.

Krsnak's device relies on limit switches in the motorized door opening system to which the device interfaces to determine complete open/close cycles. The motorized door opener is only designed to recognize, and automatically stop movement at a fully open and fully closed position, but there is no teaching or suggestion for the control system to receive signal inputs from any other switches that would not cause the door to automatically stop. Furthermore, even with such additional inputs, Krsnak's device would only be able to determine when a door has reached discrete extreme limits, e.g. fully closed and 7 feet open, and would have no indication of where the door might otherwise be at any given time.

### SUMMARY OF THE INVENTION

A spring cycle tracker system for a door mounted on a track having at least one spring and the door having an open and closed position. The system has at least one sensed element and a tracker. The tracker has a sensor having at least one sensing element; and a controller having a counter display, at least one input signal from the at least one sensing element and at least one output signal. The sensed element and the tracker are mounted such that when the door is moved towards the open position and/or the closed position, the sensed element and the controller are moved relative to each other so that the sensing element senses the sensed element, sending an input signal to the controller, incrementing the counter display, tracking a number of times the spring is used. The sensed element and the tracker are mounted at a height greater than 50% of the total height of the door when the door is in the closed position.

### BRIEF DESCRIPTION OF THE DRAWING

FIG. 1 shows a section of an interior elevation of a sectional overhead door in a closed position.

FIG. 2 shows a side view of the interior of a sectional overhead door in a closed position.

FIG. 3 shows a schematic of the cycle tracker and the overhear door moving towards an open position.

FIG. 4 shows a schematic of a control scheme to increment the counter display of the cycle tracker.

FIG. 5 shows an alternative cycle tracker.

FIG. 6a shows a side view of the interior of a sectional overhead door in a closed position and the orientation of two accelerometer axes at different locations when the door is opened/closed.

FIG. 6b shows a diagram of a cycle tracker utilizing an accelerometer.

FIG. 7a shows example output of an accelerometer axis sensitive in a direction of motion.

FIG. 7b shows example output of an accelerometer axis orthogonal to a direction of motion at all times, while also transitioning from a direction orthogonal to gravity to a direction parallel to gravity.

FIG. 7c shows the sum of the data points in FIGS. 7a and 7b.

FIG. 8 shows a cycle tracker utilizing a magnetic sensor and variably spaced magnets.

FIG. 9 shows an example output of a magnetic sensor.

FIG. 10 shows a cycle tracker utilizing an ultrasound transducer.

FIG. 11. shows an example output of an ultrasound transducer.

### DETAILED DESCRIPTION OF THE INVENTION

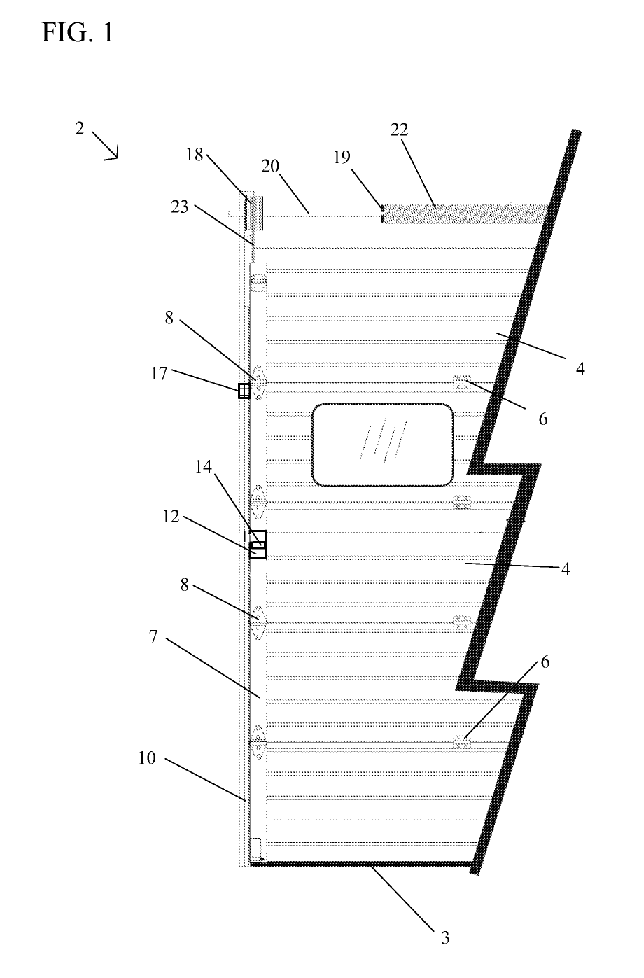

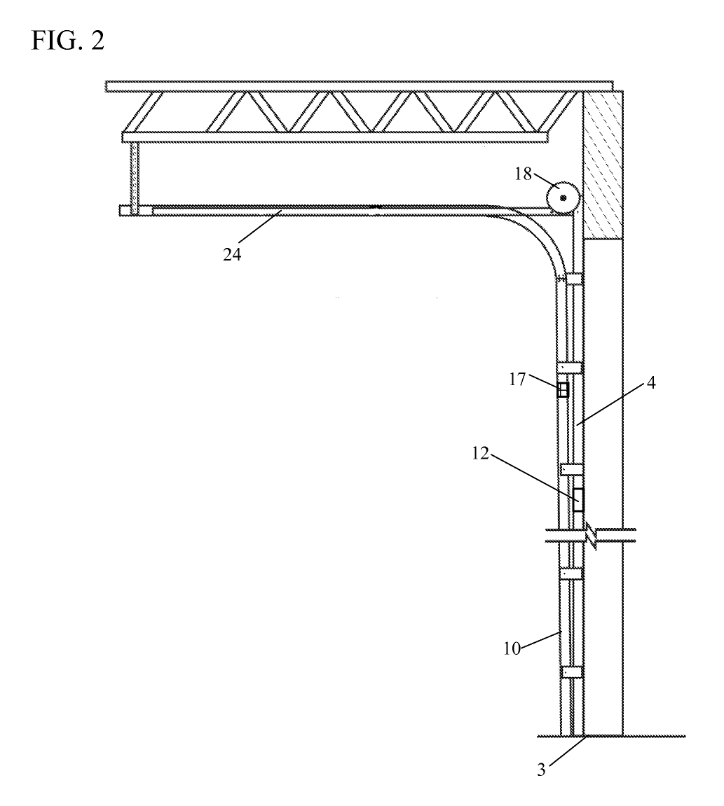

FIGS. 1-2 show an overhead door 2 in the closed position with a cycle tracker 12 of the present invention. The overhead door 2 includes a series of sections 4 that are connected to each other by hinges 8 near the outer edge 7 of the door and another set of hinges 6 between the sections 4 and the outer edges 7. It should be noted that only one set of hinges 8 on the outer edge 7 and one set of hinges 6 between the outer edges 7 are shown in FIG. 1. Additional hinges may be present.

Above the overhead door 2 is mounted a torsion spring counterbalance system. The torsion spring counterbalance system includes a torsion spring 22 on a torsion shaft 20 mounted over the overhead door 2 with a winding cone 19 on one end and a stationary cone (not shown) at the other end. At the ends of the torsion shaft 20 are cable drums 18. Counterbalance cables 23 run from the vertical tracks 10 at the bottom corners of the overhead door 2 to the cable drums 18.

The outer edges 7 of the sections 4 of the overhead door 2 are mounted on a vertical track 10. The vertical track 10 transitions into a horizontal track 24 as shown in

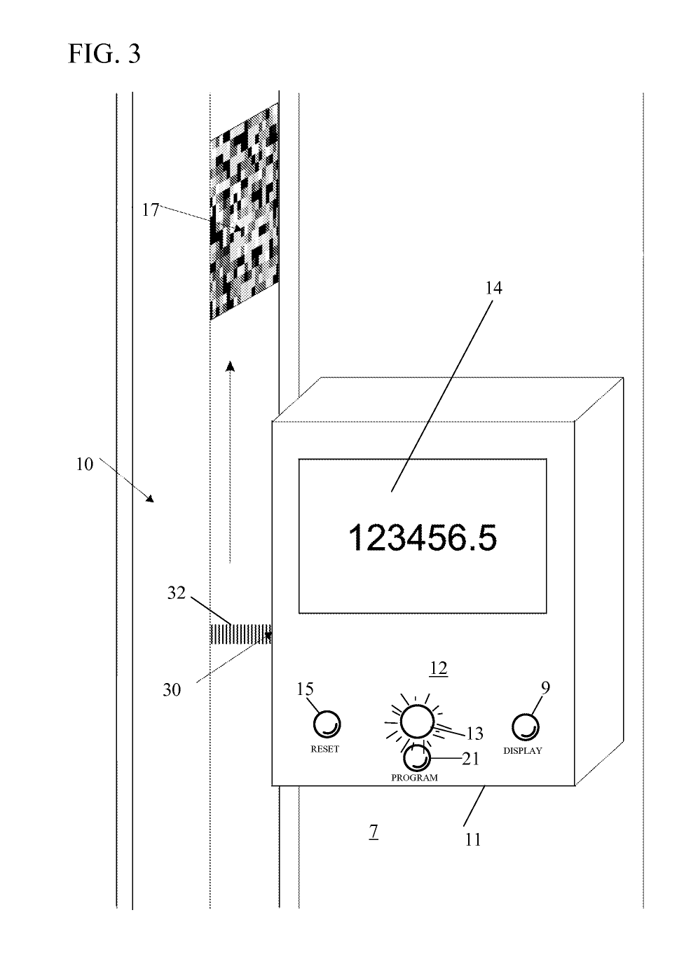

FIG. 2. In one embodiment, shown in FIG. 3, attached to the vertical track 10 of the overhead door 2 is reflective tape 17 or some other type of reflective material. Attached to an outer edge 7 of one of the sections 4 of the overhead door 2 is a cycle tracker 12. The cycle tracker 12 tracks the number of overhead door 2 cycles or spring cycles which can be used to predict the remaining life or the remaining number of life cycles of the spring 22. One spring cycle is equivalent to one door cycle, with each door cycle equal to one opening and closing of an overhead door 2.

By knowing the approximate life cycle of the spring 22, through tracking the number of times the spring 22 has been used or the number of cycles that have already taken place through the number of door cycles, the remaining life cycle of the spring 22 may be predicted and the torsion spring 22 can be replaced prior to it breaking or snapping, decreasing the possibility of injuring people and property.

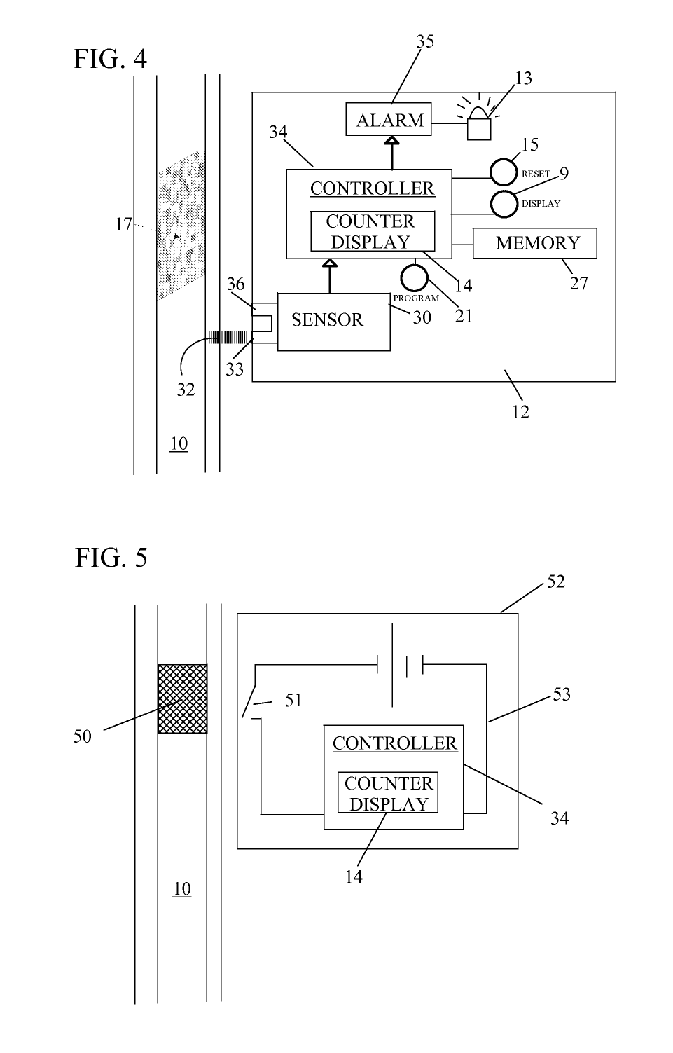

As shown in FIG. 4, an audible alarm 35 of the cycle tracker 12 may sound a warning, indicating when the torsion spring 22 is approaching a certain percentage of life remaining, or may also be set when the number on the counter display exceeds a specific number of spring cycles. For example, the alarm may sound a warning if 20% of the life cycle of the spring 22 remains or if the counter display exceeds 8000 spring cycles. Additionally, the cycle tracker 12 may also have, either separately or in conjunction with the audible alarm, as shown in FIG. 3, a visible alarm 13 in the form of a light to indicate when the counter display reaches a specific number of spring or door cycles.

Referring to FIG. 3, the cycle tracker 12 includes a body or plate 11 that is mounted at the outer edge 7 of a section 4 of the overhead door 2. A counter display 14, which is preferably part of a controller 34, preferably has at least six digits visible and is actuated to increment by the controller 34. The controller 34 is not limited to the inputs and outputs shown within the drawings. The counter display 14 is preferably resettable, for example through a reset button 15 in one embodiment, and may be digital. Further, the controller 34 is preferably configured to have a learning mode in which it can detect and store sensor responses for each specific installation if necessary. Entry to a learning mode is accomplished in one embodiment by simultaneously pressing and holding both the reset button 15 and the display button 19 for a predetermined period, or may be implemented through a dedicated programming input 21.

As shown in FIG. 4, within the cycle tracker 12 is a sensor 30 which contains both an emitter 33 and a sensor receiver 36. The sensor 30 may be an optical diffuse-mode sensor, where light emitted from the sensor strikes the surface of an object to be detected (in this case the reflective tape 17), and is diffused back or sends some light back to the receiver 36. Therefore, the reflective tape 17 is detected when the beam of light 32 hits the reflective tape 17 and reflects back the sensor's transmitted light energy back to the sensor. Other type sensors, such as a retroreflective sensor, divergent-mode sensors, or convergent-mode sensor may also be used.

When the reflective tape 17 is detected, the sensor 30 sends an input signal to a controller 34. The controller 34 increases the counter display 14 by 0.5. If the number on the counter display 14 exceeds a preset number, the controller 34 sends an output signal to an alarm 35. The alarm 35 may be a visual alarm, an audible alarm or both. Both the alarm 35 and the counter display 14 may be resettable, and the processor may contain on-board memory and/or external memory for storing learned inputs and current count when the battery is changed.

Looking, then, at a complete door cycle from closed, to open and back to closed, the counter system works as follows:

When the overhead door 2 is raised to an open position, the torsion spring 22 unwinds and the stored tension aids in lifting the sections 4 of the overhead door 2. The wheels on the sections slide in the vertical track 10 and transition onto the horizontal track 24. The spring 22 takes up the weight as the door moves by turning the shaft 20, thus turning the cable drums 18, and wrapping the cables 23 around the cable drums 18.

As the overhead door 2 is moving onto the horizontal track 24, the cycle tracker passes the reflective tape 17. Light emitted from the sensor 30 of the cycle tracker 12 strikes the reflective tape 17, and reflects back the sensor's transmitted light energy back to the sensor 30. The sensor 30 sends an input signal to the controller 34. The controller 34 increases the counter display 14 by 0.5. If the number on the counter display 14 exceeds a preset number, the controller 34 sends an output signal to an alarm 35.

To close the door from the open position described above, the overhead door 2 is lowered to a closed position in which an edge of one of the sections 4 is in contact with the ground 3. In the closed position the sections 4 of the overhead door 2 are on the vertical track 10. As the door closes, the cables 18 unwrap from the drums 18 and the torsion spring 22 is rewound to full tension.

As the overhead door 2 is moving towards the closed position, the cycle tracker once again passes the reflective tape 17. As it does, light emitted from the sensor 30 of the cycle tracker 12 strikes the reflective tape 17, and reflects back the sensor's transmitted light energy back to the sensor 30. The sensor 30 sends an input signal to a controller 34. The controller 34 then increments the counter display 14 to increase the counter display by 0.5. If the number on the counter display 14 exceeds a preset number, the controller 34 sends an output signal to an alarm 35 and visual indicator 13 if present.

Thus, for each complete cycle of door opening and door closing, the counter display 14 is increased by 0.5 twice—therefore, one complete door cycle of an opening and closing of the door increases the counter display 14 by one. One door cycle is equivalent to one spring cycle.

In an alternate embodiment, the cycle tracker 12 may only track when the overhead door 2 is moved to an open position.

The cycle tracker 12 is preferably attached to a section 4 of the overhead door 2 at eye level of a user or greater than 50% of the height of the door when the door is in the closed position. However, this should not be viewed as a structural limitation as it is preferred only for convenience of viewing the counter display 14.

In another embodiment of the present invention, the spring cycles may be tracked when the door is moving in only one direction (up or down) by placing two separate sensors 30 with two separate sensing or receiving elements 36 at different locations offset from each other. The two receiving elements 36 provide input to a controller 34 within a cycle tracker 12. In other words, two reflective strips 17 with a large relative distance vertically between them along the door track 10, 24 as well as horizontally offset relative to each other and the door track 10, 24 are independently sensed, and only counted when a first receiving element of a first sensor detects the reflective material before the second receiving element of a second sensor, indicating that the door is moving in a selected direction. When this occurs, the counter display is increased by one by the controller 34.

In another embodiment which would allow the counting to only occur when the door is moving in one direction, the reflective material 17 is patterned to have non-reflective portions in a specific pattern, such that when a sensor receiver 36 receives transmitted light from the reflective material 17 and the overhead door 2 is moving one way—for example, towards an open position—the sensor 30 will sense light transmitted or reflected in a pattern such as on-off (long)-on-off(short)-on. When overhead door 2 is moving in the other direction—towards a closed position—the light transmitted to the sensor 30 or reflected in a different pattern such as on-off(short)-on-off(long)-on. By being able to determine which way the door is moving, the counter display 14 can be incremented either for both opening and closing, or just if the door is moving in one direction, open or closed. It will be recognized that other reflective patterns may be used and detected over a large distance for more accurate detection of door position.

In an alternate embodiment, as shown in FIG. 5, the reflective material 17 may be replaced by a magnet 50, and the optical sensor is replaced by a magnetic sensor 51, such as a reed switch or induction sensor. The counter display 14 is incremented when the overhead door 2 approaches the magnet 50 and actuates a switch 51 to complete the circuit 53 within the cycle tracker 52. A controller 34 includes a counter display 14 to monitor the number of door cycles or spring cycles and send a signal to trigger an alarm. Other elements of the cycle tracker shown in FIG. 4 have been omitted for clarity, but are equally applicable to this embodiment.

In another embodiment, which allows counting to only occur when the door is moving in one direction, magnets 50 are placed horizontally and vertically offset on each door track at different heights, and the counter display 14 is only increased when a first sensor 51 detects the magnet before a second sensor 51 detects the magnet.

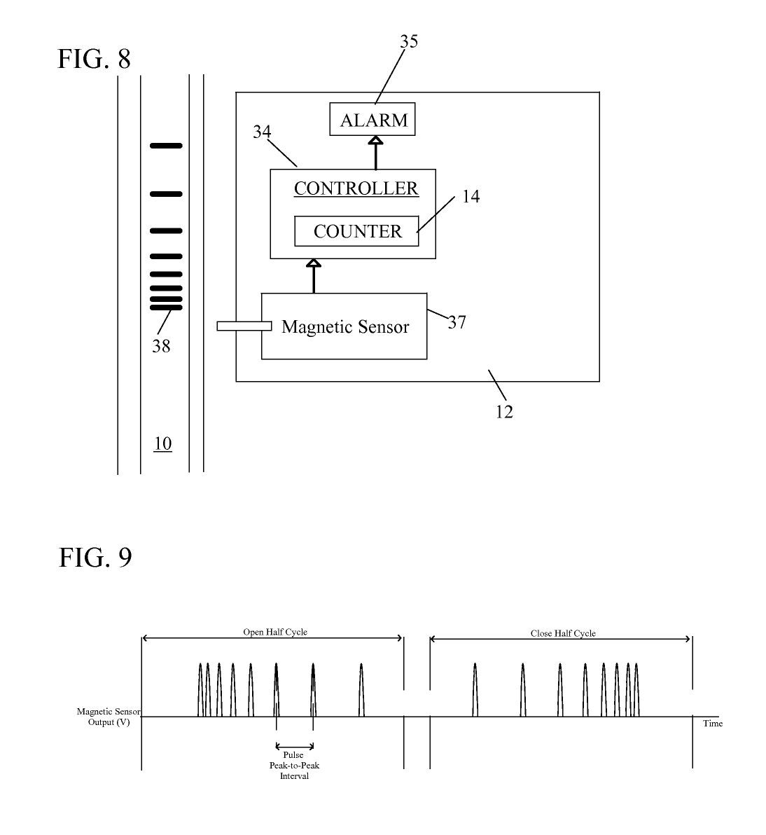

In an alternative embodiment, as shown in FIG. 8 and FIG. 9, a magnetic sensor 37 is combined with a plurality of magnets 38 that are linearly arranged with progressively smaller spaces between them along the vertical track 10. Thin strips of magnetic material with an adhesive strip backing may be used for consistency and ease of installation. Thus, as shown in FIG. 9, the controller 34 is presented with a decreasing rate of pulses as the sensor 37 moves up past the plurality of magnets 38, and an increasing rate of pulses as the sensor 37 moves down past the plurality of magnets 38. Such an arrangement allows a distinction to be made between up and down cycles, and also partial openings and closings. For partial openings and closings, the total distance over which the magnets 38 are applied is sufficiently long, such that the controller 34 is capable of determining pulse peak-to-peak interval, correlated to door position, and the total number of pulses it has received. Any number of pulses less than a pre-set value would indicate a partial open/close of the overhead door 2, which is confirmed by the peak-to-peak interval last determined.

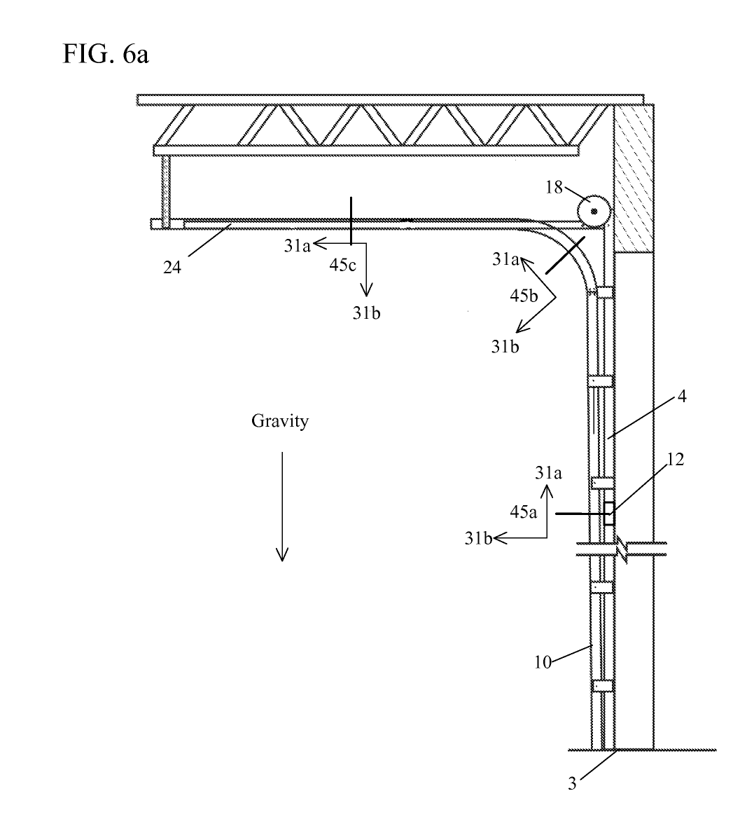

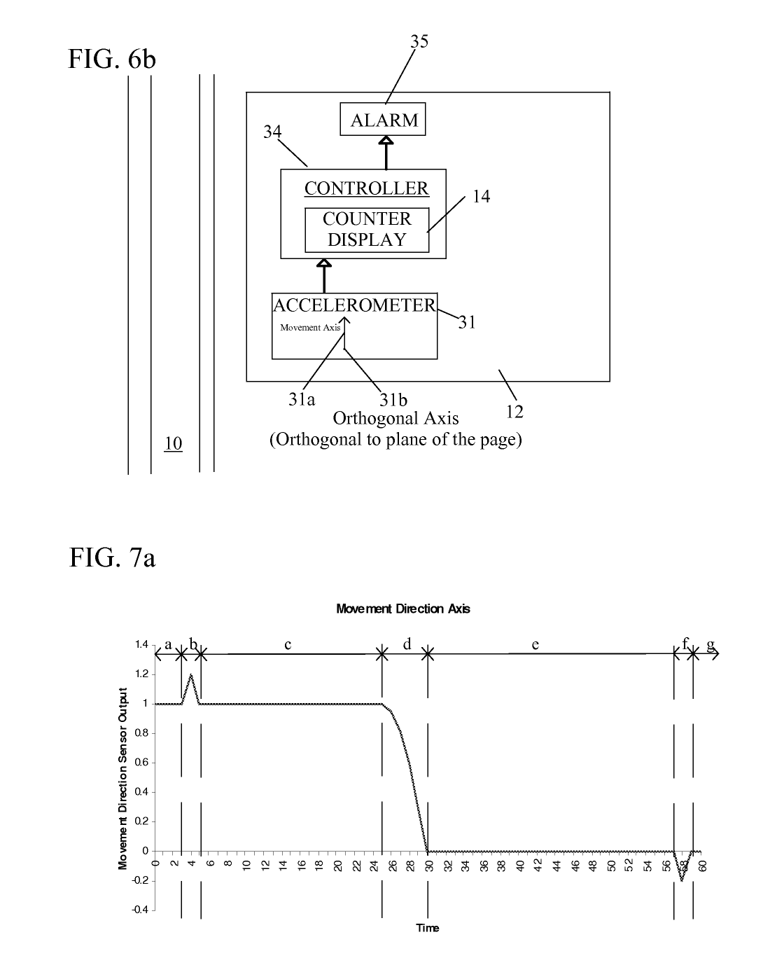

In another embodiment, as shown for example in FIG. 6a and FIG. 6b, the sensor element is an accelerometer 31 having at least one motion direction axis 31a that is always aligned with the direction of motion of the door. For example, as the door 2 starts from a closed position and begins to move upward along vertical track 10 at position 45a, the motion direction axis 31a is oriented vertically along the vertical track 10. As the door transitions from the vertical track 10 to the horizontal track 24, for example at position 45b, the orientation of the motion direction axis 31a tilts but remains in the direction of motion of the door 2 as the door 2 moves to an open position. Finally, as the overhead door 2 reaches a horizontal orientation at point 45c on horizontal track 24, the motion direction axis has fully tilted out of its original orientation at 45a, but is still oriented in the direction of motion of the door.

Similarly, the accelerometer 31 may also include an orthogonal axis 31b. At position 45a, 45b, and 45c, this orthogonal axis 31b is always orthogonal to the direction of motion, and thus insensitive to the motion of the door. However, as one can appreciate from the gravity vector shown in FIG. 6a, the orientations of both the motion direction axis 31a and the orthogonal axis 31b both change relative to gravity at various overhead door 2 positions. For example, at position 45a, the motion direction axis 31a is fully aligned with gravity, while the orthogonal axis 31b is insensitive to it. At position 45b, both the motion direction axis 31a and the orthogonal axis 31b are at least partially aligned with gravity. And finally at position 45c, the motion direction axis 31a is orthogonal to gravity, and therefore insensitive to it, while the orthogonal axis 31b is oriented along the gravity vector and therefore sensitive to it.

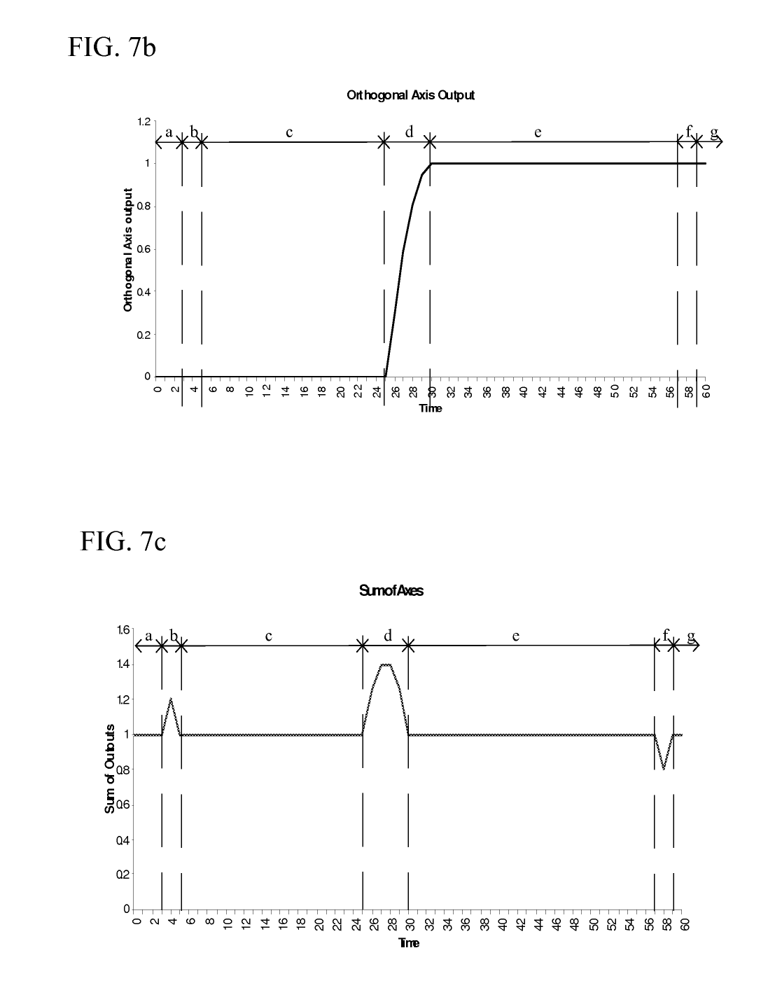

FIG. 7a shows a simplified output from the motion direction axis 31a which is sensitive in the direction of the overhead door 2 movement during a complete opening/closing operation cycle. The signal from the motion direction axis 31a can be described, for example during an opening operation, in terms of various phases of overhead door 2 operation:

a) The overhead door 2 is fully closed and stationary; hence the motion direction axis 31a experiences normal acceleration of 1 g (local standard gravity).

b) The overhead door 2 starts opening, causing an additional acceleration which is sensed by the motion direction axis 31a.

c) The motion direction axis 31a returns to a normal 1 g output as the overhead door 2 continues to open at a constant velocity.

d) As the overhead door 2 transitions from a vertical orientation to a horizontal orientation, the motion direction axis 31a is no longer sensitive to gravity, and only registers accelerations in the direction of overhead door 2 movement.

e) The overhead door 2 continues moving at a constant velocity until it is fully opened so the motion direction axis 31a, no longer sensing gravity, gives a zero output.

f) When the overhead door 2 reaches its terminal fully open position, the motion direction axis 31a senses a deceleration.

g) The motion direction axis 31a returns to a zero output as long as the overhead door 2 remains open.

This sequence of signals is interpreted as one opening, and hence registers as 0.5 cycles on the controller 34 and counter display 14. It should be clear to one skilled in the art, that the actual signal outputs discussed above will be more complicated during the period of movement, and transition of the door from the horizontal to the vertical, but that only an acceleration at the start of opening, and a deceleration after a given time period are required to define a full opening cycle. It will further be appreciated that the signals shown will depend on the coordinate system used in determining the sign of accelerations and decelerations relative to gravity.

It is further understood that a variety of signal filtration schemes commonly known in the art of signal processing can be applied, either through the controller or hardware filters, to simplify the interpretation of signals and remove unwanted noise caused, for example, by vibration. One can also appreciate that during a door 2 closing operation, the signal pattern shown in FIG. 7a would run in reverse temporal order, and the accelerations and decelerations, at b) and f), would reverse their sign accordingly. This sequence of signals is similarly interpreted as one closing, and hence registers as 0.5 cycles on the controller 34 and counter display 14.

FIG. 7b shows a simplified signal output of the orthogonal axis 31b when the door starts in a fully closed position and is moved to a fully open position. During phases a), b), and c) described above, this orthogonal axis 31b registers no acceleration. Only when the orthogonal axis 31b changes orientation as the overhead door 2 transitions from a vertical position to a horizontal position going from position 45a, through 45b, and finally to 45c, does the orthogonal axis 31b begin to register gravity in phase d), and continues to do so through following phases of movement of, e) and f).

Adding the output of both axes 31a, 31b results in a simplified signal pattern shown in FIG. 7c. This additive signal is substantially constant forming a baseline, except during phase d), and includes appropriate accelerations/decelerations at the start of the opening operation b) and the end of the opening operation f). As pointed out above, this additive signal is substantially the same during closing operations, except the sign of the accelerations in the respective phases b) and f) are reversed in sign and the sequence of events occurs in reverse order.

Since the duration of output of the accelerometer 31 through axes 31a and 31b, and the time between the start acceleration and end deceleration in each movement cycle are directly correlated to the distance the overhead door 2 travels from a fully closed position to a fully open position, the controller 34 can discriminate between cycles where the door is fully opened and closed, and cycles where the overhead door 2 has only been partially opened or closed and returned to its respective starting point. Hence, these partial openings or closings can be excluded from counting if desired and a set point may be programmed, for example at a door open height of 6 feet, as the discriminating parameter.

Although the preceding discussion has focused on an accelerometer of the piezoelectric class, it will be clear to one skilled in the art that other types of accelerometers, such as potentiometric, linear variable differential transformer (LVDT), variable reluctance, MEMS-based, gyroscopic, or others may also be used, and their specific outputs monitored and interpreted accordingly.

The controller 34 is also equipped with a program mode that allows it to “learn” a signal pattern for each installation environment at the time of installation. In one embodiment, a program button 21 is provided that allows the installer to place the controller 34 in a learn mode. Alternatively, a learning mode can be entered and exited by pressing and holding a pair of inputs for different functions. Once placed in learning mode, the user executes a complete overhead door 2 open action, a waiting period to mark the end of the opening, then a complete closing action, followed by another actuation of the learn mode program button 21. The controller 34 may give an audible cue after the accelerometer 31 signals have stabilized for a preset period of time after opening has completed, notifying the user that the door may be fully closed to complete the learning cycle, as well as an audible signal after the door has been fully closed and the learning cycle is complete.

The controller 34 is then able to apply simple rules (e.g., sign of signals, time between peaks, etc) to separate the open and close signals, and store their critical parameters for use as rule sets for evaluating future overhead door 2 movements. The controller 34 may also be programmed to sense and compensate for minor changes in signal parameters, e.g. voltage level outputs and signal durations, which may result from potential drift in the accelerometer 34 output over time, and update its stored parameters, or reset electronic components, as necessary. For example, when the door is in a fully closed position, and the controller 34 may recalibrate itself, or prior to entering a “sleep” mode to save power the controller 34 may also recalibrate.

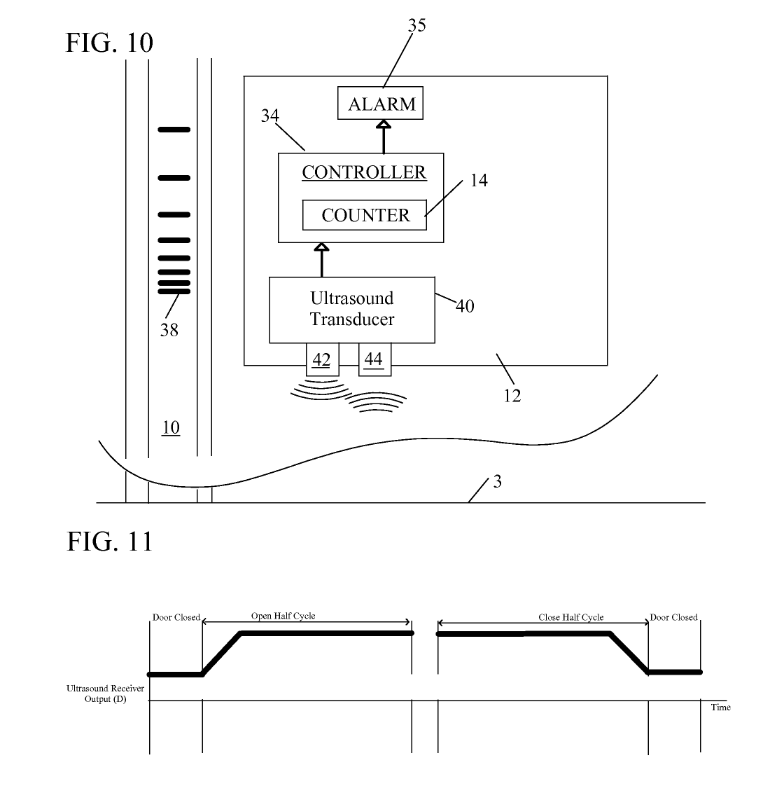

In another embodiment, shown in FIG. 10 and FIG. 11, an ultrasound transducer 40 having a send module 42 and a receive module 44 is employed. The send module 42 transmits sound waves that are reflected from the ground 3 back to the receive module 44 and interpreted as a distance (D). When the overhead door 2 is in a closed position, the receive module 44 measures a constant distance to the ground. When the overhead door 2 opens, the distance (D) measured by the receive module 44 and conveyed to the controller 34 increases, indicating an opening half cycle. Similarly, when the overhead door 2 closes, the receive module 44 conveys a decreasing distance to the controller 34, indicating a closing half cycle.

A program button 21 on the cycle tracker 12 allows the fixed distance to the ground 3 in the closed position to be determined and stored, as well as the pattern of the signal input from the receive module 44 when the overhead door 2 is opened and allowed to remain so for a period. Similarly, the pattern of the signal input from the receive module 44 during closing of the overhead door 2 can then also be recorded and stored for comparison to future overhead door 2 movement to sense complete or incomplete open and close half cycles, incrementing the counter display 14 appropriately. The output shown in FIG. 11 is simplified, as it is understood that the sensor output during the opening or closing phase of the overhead door 2 may be more complex depending upon how the cycle tracker 12 moves with the door in relation to nearby structural features. However, as previously described, the learning phase allows the controller 34 to learn individual patterns of signal input at installation by storing a start output of the ultrasound receiver 44 (i.e., distance to ground when door is closed), and an output of the ultrasound receiver 44 over a period of opening until the door is fully open and the ultrasound receiver 44 output stabilizes for a predetermined period of time. Similarly, during a closing cycle the pattern of the signal input is tracked and stored as the overhead door 2 is closed after a stabilization period until the cycle tracker 12 reaches an original start value where the overhead door 2 was closed. The controller 34 activates an audible cue through alarm 35 to indicate when an appropriate level of signal stabilization has occurred, and a close half cycle can be started for learning purposes.

While the drawings and the discussion above have the cycle tracker 12 mounted on the overhead door 2 and the sensed element (reflective material 17, magnet 50, or plurality of magnets 38) mounted at a fixed location near or on the track, it will be understood that the invention contemplates simply that the two elements be arranged such that a moving element (be it the tracker or the sensed element) passes by the fixed element (the other of the sensed element or the tracker). Therefore, the opposite arrangement to that discussed previously is also possible, in which the cycle tracker 12 is mounted to a fixed location adjacent to the door—either on the vertical track 10 or on the horizontal track 24 or at a location adjacent to one of the tracks—and the sensed element is mounted to the moving overhead door 2. In such an arrangement the sensed element (reflective material 17, magnet 50, or plurality of magnets 38) is preferably attached to a section 4 of the overhead door 2 at eye level of a user or greater than 50% of the height of the door when the door is in the closed position.

While a digital counter display is described, other types of counter displays that may be electrically or electronically actuated may also be used.

While the cycle tracker 12 is described and shown in reference to an overhead door 2 with a torsion spring counterbalance system, one skilled in the art could be expected to apply the cycle tracker to an overhead door with extension springs.

While the overhead door is shown as being comprised of segments, the door may also be of the type that lifts in one piece.

While the function of the controller 34 has been discussed primarily with regard to its operative interaction with a variety of sensor arrangements, the controller is capable of additional features such as activating a sleep mode of the counter display 14 in order to save power, activating a backlight on the counter display 14 for a fixed period after the end of a close half cycle, integration of a user input through a display button 9 or other means to wake the counter display 14 from sleep mode in order to view counts without opening and closing the overhead door, integration of a battery low alarm that would warn the user to change the battery, a diagnostic function that is activated when a battery is inserted while a control button is held in a depressed state, and other similar usability functionality, and include additional volatile and/or non-volatile memory 27 for those purposes as necessary.

Accordingly, it is to be understood that the embodiments of the invention herein described are merely illustrative of the application of the principles of the invention.

Reference herein to details of the illustrated embodiments is not intended to limit the scope of the claims, which themselves recite those features regarded as essential to the invention.

What is claimed is:

1. A spring cycle tracker system for a track-mounted door having at least one spring, the door having an open position and a closed position, and a direction of travel between the open position and the closed position, the system comprising:
a spring cycle tracker mounted to the door at a height greater than 50% of the total height of the door when the door is in the closed position, comprising:
a sensor having at least one sensing element and an output; and
a controller having a counter display and an input coupled to the output of the sensing element;
such that when the door is moved, the sensor and the controller move with the door, the sensor generates a signal on the output of the sensor correlated to the door motion, and the controller senses the signal from the sensor on the input and increments the counter display, such that the counter display tracks a number of times the spring is used.

2. The spring cycle tracker system of claim 1, in which the sensing element is an accelerometer having a first axis sensitive to movement in a direction of travel of the door.

3. The spring cycle tracker system of claim 2, in which the accelerometer further comprises a second axis orthogonal to the first axis; said second axis being aligned with gravity when the door is in a horizontal position.

4. The spring cycle tracker system of claim 1, further comprising a memory addressable by the controller.

5. The spring cycle tracker system of claim 1, in which the sensing element is an ultrasound transducer having at least one send element and at least one receive element with a sensitive range, the controller being programmed to interpret the signal from the at least one receive element as a distance between the at least one receiver and a closest surface within the sensitive range of the at least one receiver when the door is moved between an open position and a closed position.

6. The spring cycle tracker system of claim 1, in which the sensing element is a magnetic sensor.

7. The spring cycle tracker system of claim 6, further comprising
a plurality of magnets arranged in a linear array having a first end and a second end, each magnet of the plurality of magnets being separated from adjacent magnets in the linear array by an increasing distance in sequence from the first end of the linear array to the second end of the linear array;
the linear array of magnets being arranged in proximity to the door so as to be detectable by the magnetic sensor,
such that as the door is moved and the magnetic sensor moves past the linear array of magnets, the magnetic sensor outputs a plurality of pulses, each pulse being correlated to passage of the one of the plurality of magnets in the linear array past the magnetic sensor.

8. The spring cycle tracker of claim 7, in which the controller is programmed to count the number of pulses, and calculate differences in length of a pulse interval between pulses, and to use the number of pulses and pulse intervals to determine a position of the door.

9. The spring cycle tracker of claim 1, further comprising an audible output connected to an output of the controller.

10. The spring cycle tracker of claim 1, further comprising a visual output connected to an output of the controller.

11. The spring cycle tracker of claim 1, in which the controller executes a learning mode in response to a user input in which a first door movement from a fully closed position to a fully open position is monitored and stored as a baseline for comparison to future opening operations, and a second door movement from a fully open position to a fully closed position is monitored by the controller and stored as a baseline for comparison to future closing operations.

12. The spring cycle tracker of claim 11, in which the controller initiates a first audible signal instructing the user to start a first door movement from a fully closed position to a fully open position, and a second audible signal instructing the user to start a second door movement from a fully open position to a fully closed position

13. The spring cycle tracker of claim 1, in which the controller executes a sleep mode that turns the counter display on when door movement is detected, and turns the counter display off after a preset delay when no door movement is detected.

14. The spring cycle tracker of claim 13, further comprising an at least second user input element to the controller to return the counter display from sleep mode to a display mode.

15. The spring cycle tracker of claim 1, in which the controller performs a diagnostic test of the spring cycle tracker when at least one user control input element is actuated while a battery is being installed in the spring cycle tracker.

16. The spring cycle tracker of claim 1, in which the controller is programmed to calculate a time period between a start and an end of the signal on the sensor output, and does not increment the counter display when the time period is less than a determined value.
